(19) United States
(12) Patent Application Publication
(10) Pub. No.: US 2005/0251757 A1
(43) Pub. Date: Nov. 10, 2005

(54) Display of enlarged visual container graphical user interface (GUI) components during GUI layout or design

(75) Inventor: Brian G. Farn, Toronto (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, ARMONK, NY (US)

(21) Appl. No.: 11/121,654

(22) Filed: May 4, 2005

(30) Foreign Application Priority Data
May 4, 2004 (CA) 2,466,253

(51) Int. Cl. G06F 3/00; G06F 17/00

(52) U.S. Cl. 715/810; 715/815; 715/823; 715/800; 715/517

(57) ABSTRACT

During Graphical User Interface (GUI) layout and design, selection of a GUI component causes either the selected component or an ancestor of the selected component to be displayed in a design area. If the selected component is capable of displaying other GUI components within its boundaries, it is the selected component that is displayed in the design area. Otherwise, an ancestor GUI component of the selected component that is capable of displaying other GUI components within its boundaries is displayed in the design area. The displayed component is displayed in a size that is larger than its usual display size, so that component features may more easily be seen and, if desired, manipulated. The larger size may fill the design area. Selection may be effected by a designer or by automatic programmatic selection, e.g., by layout editor software, and may in some cases be a reselection.

### FIELD OF THE INVENTION

The present invention relates to graphical user interfaces (GUIs), and more particularly to the layout and design of GUIs.

### BACKGROUND OF THE INVENTION

Graphical User Interface layout editors are commonly used by computer programmers and user interface designers to arrange GUI components on a user interface form during GUI layout and design. The place (i.e. screen area) within a layout editor where a person arranges GUI components is called a design area. Known layout editors usually present the entirety of a form being edited in the design area. When a designer works on a subset of the design, such as a menu bar or composite (i.e. dialog box), other GUI components not presently being edited continue to be displayed. The result is a cluttered design area in which the component(s) presently being edited may be effectively lost among the other components or may be displayed in a size that is too small to permit easy viewing of component features.

A solution that addresses the above noted difficulty would be desirable.

### SUMMARY OF THE INVENTION

During GUI layout and design, selection of a GUI component causes either the selected component or an ancestor of the selected component to be displayed in a design area. If the selected component is capable of displaying other GUI components within its boundaries, it is the selected component that is displayed in the design area. Otherwise, an ancestor GUI component of the selected component that is capable of displaying other GUI components within its boundaries is displayed in the design area. The displayed component is displayed in a size that is larger than its usual display size, so that component features may more easily be seen and, if desired, manipulated. The larger size may fill the design area. Selection may be effected by a designer or by automatic programmatic selection, e.g., by layout editor software, and may in some cases be a reselection.

In accordance with an aspect of the present invention there is provided a method for use in graphical layout or design of a GUI, the method comprising: upon selection of a visual GUI component that is capable of displaying other GUI components within its boundaries, the visual GUI component having a display size that is less than a size of a design area, displaying the visual GUI component within the design area in an enlarged size greater than the display size.

In accordance with another aspect of the present invention there is provided a method for use in graphical layout or design of a GUI, the method comprising: upon selection of a visual GUI component that is not capable of displaying other GUI components within its boundaries: identifying an ancestor visual GUI component of the visual GUI component, the ancestor being capable of displaying other GUI components within its boundaries, the ancestor having a display size that is less than a size of a design area; and displaying the ancestor visual GUI component within the design area in an enlarged size greater than the display size.

In accordance with yet another aspect of the present invention there is be provided a computer readable medium for use in graphical layout or design of a GUI, the computer readable medium containing computer-executable instructions that, when performed by a processor in a computing device, cause the computing device to: upon selection of a visual GUI component that is capable of displaying other GUI components within its boundaries, the visual GUI component having a display size that is less than a size of a design area, display the visual GUI component within the design area in an enlarged size greater than the display size.

In accordance with still another aspect of the present invention there is be provided a computer readable medium for use in graphical layout or design of a GUI, the computer readable medium containing computer-executable instructions that, when performed by a processor in a computing device, cause the computing device to: upon selection of a visual GUI component that is not capable of displaying other GUI components within its boundaries: identify an ancestor visual GUI component of the visual GUI component, the ancestor being capable of displaying other GUI components within its boundaries, the ancestor having a display size that is less than a size of a design area; and display the ancestor visual GUI component within the design area in an enlarged size greater than the display size.

In accordance with yet another aspect of the present invention there is be provided a computing device for use in graphical layout or design of a GUI, the computing device comprising a processor and persistent storage memory in communication with the processor storing computer readable instructions for directing the device to: upon selection of a visual GUI component that is capable of displaying other GUI components within its boundaries, the visual GUI component having a display size that is less than a size of a design area, display the visual GUI component within the design area in an enlarged size greater than the display size.

In accordance with still another aspect of the present invention there is be provided a computing device for use in graphical layout or design of a GUI, the computing device comprising a processor and persistent storage memory in communication with the processor storing computer readable instructions for directing the device to: upon selection of a visual GUI component that is not capable of displaying other GUI components within its boundaries: identify an ancestor visual GUI component of the visual GUI component, the ancestor being capable of displaying other GUI components within its boundaries, the ancestor having a display size that is less than a size of a design area; and display the ancestor visual GUI component within the design area in an enlarged size greater than the display size.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate an exemplary embodiment of this invention:

FIG. 1 is a block diagram illustrating a computing device executing GUI layout editor software exemplary of an embodiment of the present invention;

FIG. 2 illustrates the GUI of the GUI layout editor of FIG. 1 showing a design area;

FIG. 3 is a portion of the GUI of FIG. 2 illustrating a graphical representation of the user interface component hierarchy in outline form;

FIG. 4 is a user interface component hierarchy which is graphically represented in FIG. 3;

FIG. 5 is a flowchart illustrating operation of the GUI layout editor of FIG. 1;

FIG. 6 shows a non-visual GUI component as it appears upon being selected;

FIG. 7 shows a visual container GUI component (composite) as it appears upon being selected;

FIG. 8 shows the visual container GUI component of FIG. 7 as it appears upon being reselected;

FIG. 9 shows a first type of GUI component (text entry box) that is not a visual container as it appears upon being selected;

FIG. 10 shows a second type of GUI component (menu item) that is not a visual container as it appears upon being selected;

FIG. 11 shows a third type of GUI component (radio button) that is not a visual container as it appears upon being selected; and

FIGS. 12A and 12B illustrate selection of a first wizard page and second wizard page respectively.

### DETAILED DESCRIPTION

In the description which follows, the following definitions are applicable:

| | |
|---|---|
| Layout editor | A software program which has facilities that enable |
| | a person (designer) to design an arrangement of a |
| | user interface (i.e. to perform UI layout and design). |
| Design | The graphical user interface being designed by |
| | way of the layout editor. |
| Design area | A work area within a layout editor where a designer |
| | arranges a graphical user interface, typically in a |
| | WYSIWYG (“What You See Is What You Get”) |
| | manner. GUI components may be added to, mo- |
| | dified, or removed from the design area. |
| GUI component | An entity that is used by GUI designers as a vehicle |
| | to present and/or obtain information. |
| GUI component | Each GUI component has a type, such as ‘radio |
| type | button’ or ‘entry field’. Each component type |
| | performs a specific function. |
| Visual component | A GUI component that occupies display space (i.e. |
| | “screen real estate”) in a design area when |
| | displayed, as opposed to a non-visual component |
| | that does not occupy display space. |
| Parent component | A GUI component that has at least one child GUI |
| | component. For instance, a wizard (parent) typically |
| | has at least one wizard page (child). |
| Child component | A GUI component that is directly descendent from |
| | another GUI component (see above). |
| Ancestor | A GUI component that is a parent, grandparent or |
| component | more remote predecessor of at least one GUI |
| | component. |
| Descendant | A GUI component that is the child, grandchild or |
| component | more remote successor of another GUI component. |
| Container | A container component is a visual GUI component |
| component | that is capable of displaying other visual GUI |
| | components within its boundaries when displayed. |
| | In other words, a visual GUI component displaying |
| | another visual GUI component within its boundaries |
| | is said to “contain” the component. Parent |
| | components are not necessarily container com- |
| | ponents. Container components may alternatively be |
| | referred to a “visual container components” |
| | (although, strictly speaking, this term is redundant). |
| Graphical User | An entity that holds a set of GUI components in a |
| Interface | hierarchical form. |
| component | |
| hierarchy | |
| Outline view | A user interface construct associated with the layout |
| | editor that displays a graphical representation of the |
| | hierarchy of a GUI. |
| Selected | A component becomes a selected component either |
| component | programmatically by the layout editor software, or |
| | by a designer using the layout editor. A designer |
| | selects a component with a computer input device |
| | such as a mouse, or by navigating to the component |
| | with a computer keyboard. For clarity, “selection” |
| | in this context does not refer to a user selection of a |
| | component of a completed GUI at run time. |
| Highlighted | A component to which a distinguishing visible mark |
| component | has been applied upon selection of the component to |
| | visually reflect selection. The mark may be a |
| | colored line drawn around the selected component |
| | for example. Only one component of a graphical |
| | user interface component hierarchy may be the high- |
| | lighted component at a given time. The outline view |
| | and the design area highlight the same GUI com- |
| | ponent unless the component is not a visual |
| | component. |
| Scoped component | A scoped component is a visual container com- |
| | ponent that is currently displayed in an enlarged |
| | size so as to occupy the entire design area. Filling |
| | the design area with a container component makes |
| | the container component the scoped component. |

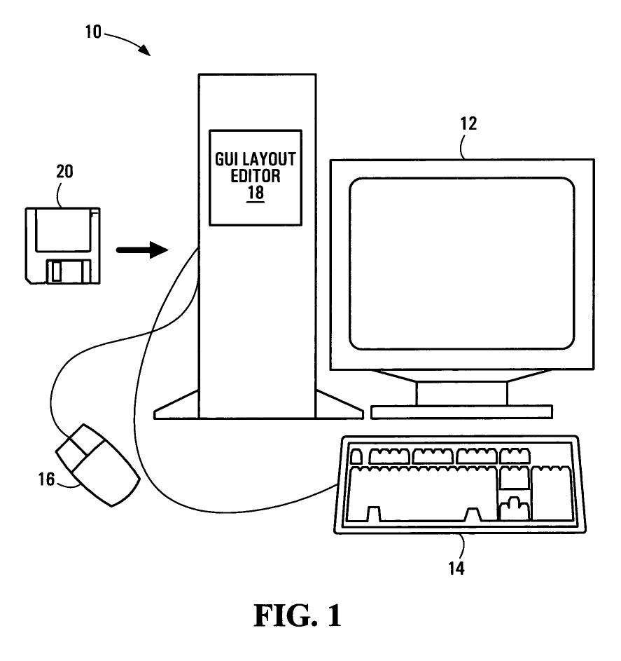

Referring to FIG. 1, a computing device 10, which may be a PC, workstation or server for example, is illustrated. The computing device 10 includes a processor (not shown) in communication with memory (also not shown), a display 12 for displaying a graphical user interface (GUI) to a user, and a keyboard 14 and pointing device 16 for receiving input from the user.

Computing device 10 executes GUI layout editor software 18 exemplary of an embodiment of the present invention. GUI layout editor software 18 (or simply “layout editor 18”) allows a human designer to graphically lay out and design one or more GUIs for the purpose of displaying information and/or receiving user input. The GUI(s) created by software 18 at design time are intended for use at run time for data input and/or output. The layout editor software 18 may be loaded into the memory of the computing device 10 from a computer readable medium, such as resident non-volatile memory (e.g. a hard drive or a read only memory chip) (not shown) or a removable optical or magnetic disk 20.

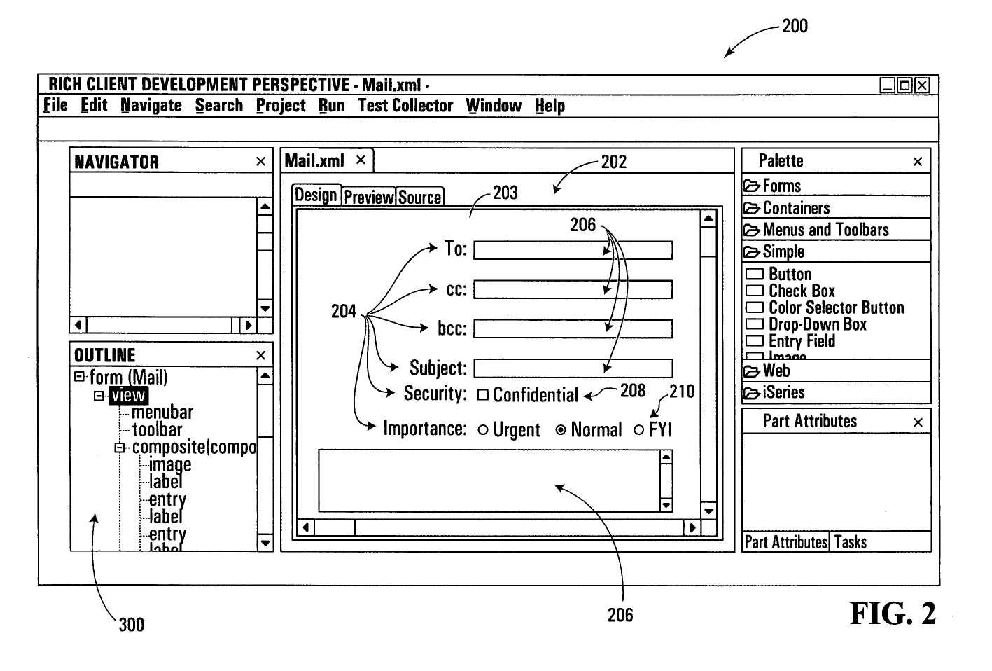

FIG. 2 illustrates a GUI 200 of the layout editor software 18. The GUI 200 includes a design area 202 and an outline view 300.

Design area 202 is a work area within the GUI of the layout editor software 18 where a designer lays out a GUI that is presently being designed. The in-progress GUI design is displayed in a “WYSIWYG” (What You See Is What You Get) manner, i.e., as it will appear when ultimately put into use, with certain exceptions (e.g. size, highlighting may be different at design versus run time), as will become apparent.

In FIG. 2, design area 202 is shown displaying a composite 203 that is part of an overall GUI for which design is in progress. The composite 203 contains various GUI components, including text fields 204, text entry fields 206, checkbox 208 and radio buttons 210.

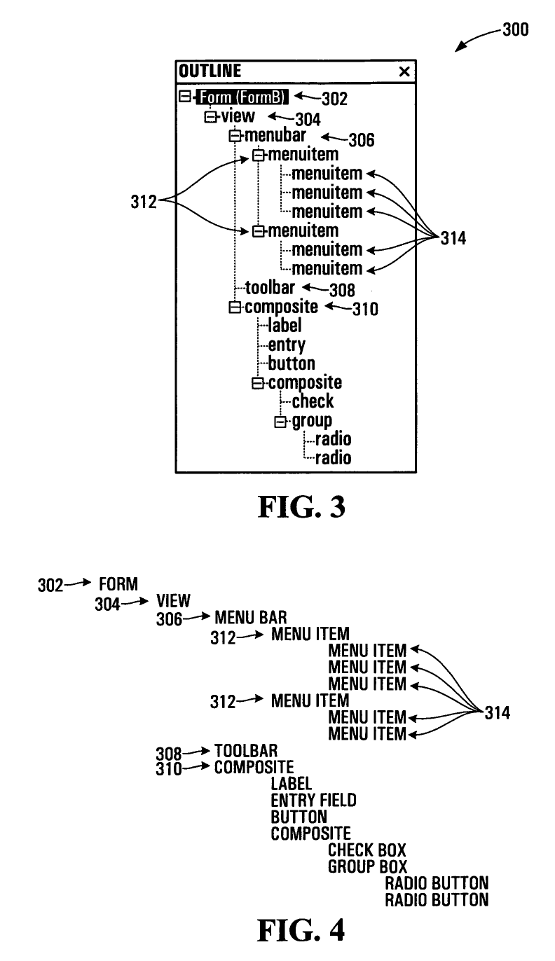

Outline view 300 displays a graphical representation of the hierarchy of the GUI presently being edited using layout editor 18. As will be appreciated, outline view 300 is “tied” to design area 202, in the sense that outline view 300 may be used to select components for display in the neighboring design area 202 or may visually distinguish (e.g. highlight) a component that has just been selected in design area 202. Such highlighting is understood to be a design time rather than a run time occurrence. Outline view 300 is shown in greater detail in FIG. 3.

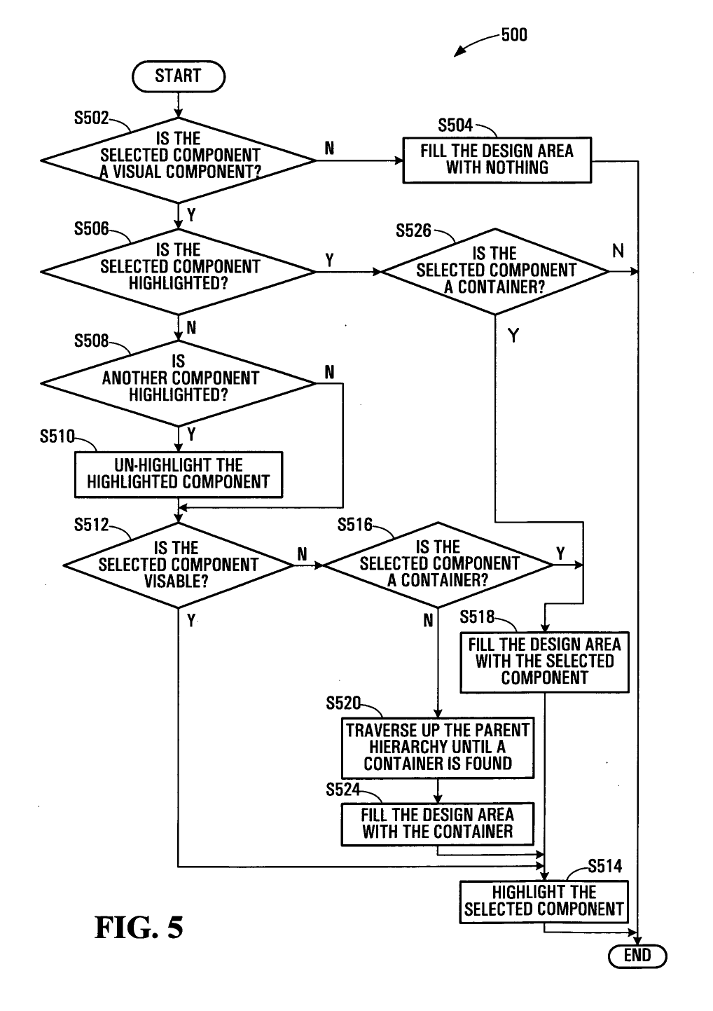

As shown in FIG. 3, outline view 300 illustrates a graphical representation of the hierarchy of GUI components. For clarity, the hierarchy illustrated in FIG. 3 represents a different GUI than that shown in FIG. 2. FIG. 3 is perhaps best viewed in conjunction with FIG. 4, which illustrates the user interface component hierarchy 400 graphically represented by the outline view 300 of FIG. 3.

With reference to FIGS. 3 and 4, a form 302 of a GUI for which design is presently in progress contains a view 304, which in turn contains a menu bar 306, toolbar 308 and composite 310. The menu bar 306 contains a pair of menu items 312. Menu items 312 each contain a further, nested set of menu items 314. As illustrated, menu bar 306 is the parent component of menu items 312 and an ancestor component of menu items 312 and 314; menu items 314 are children of menu items 312 and descendents of both menu items 312 and menu bar 306.

The remainder of the GUI component hierarchy (e.g. toolbar 308, composite 310 and the remaining GUI components) is apparent from FIGS. 3 and 4.

As known in the art, each type of GUI component (e.g. form, view, menu bar etc.) has three characteristics. The first characteristic, referred to herein as the “parent” characteristic, reflects whether or not an instance of the component type can act as a parent to other GUI components. The second characteristic, referred to herein as the “visual” characteristic, reflects whether the component type is visual, i.e. whether an instance of the GUI component can be perceived by a user (i.e. occupies “screen real estate”) when the GUI is displayed. The third characteristic, referred to herein as the “container” characteristic, indicates whether an instance of the component type can display other GUI components within its boundaries when displayed (e.g. a composite is capable of containing push button components within its boundaries). Typical visual container GUI components include views, wizards, wizard pages, menu bars, and composites. It is noted that a GUI component that is a parent is not necessarily a container. A table summarizing the three above-noted characteristics for a number of GUI component types is provided below (Table 1).

TABLE 1
Characteristics of Exemplary GUI Components

| Component | | | |
|---|---|---|---|
| type | Parent? | Visual? | Container? |
| Wizard Page | Yes, may parent | Yes | Yes, may contain other |
| | other components | | components |
| Form | Yes, may parent a | No | No |
| | view | | |
| View | Yes, may parent | Yes | Yes, may contain other |
| | other components | | components |
| Wizard | Yes, may parent | Yes | Yes, may contain wizard |
| | wizard pages | | pages |
| Menu Bar | Yes, may parent | Yes | Yes, may contain menu items |
| | menu items | | |
| Menu Item | Yes, may parent | Yes | No |
| | other menu items | | |
| Composite | Yes | Yes | Yes, may contain other |
| | | | components |
| Push button | No | Yes | No |

In overview, during layout and design of a GUI, a designer using layout editor software 18 selects GUI components as necessary (e.g. using a pointing device such as a mouse) for purposes of arranging components, changing their properties, etc., in a conventional manner. Component selection may be performed in the design area (assuming the component is already displayed in the design area so as to permit selection) or from an outline view. Alternatively, component selection may be performed automatically (i.e. programmatically) by the layout editor software 18.

Upon selection of a GUI component, the layout editor 18 automatically displays in design area 202 an enlargement of either the selected component or an ancestor of the selected component. Specifically, if the selected component is a visual container component, then the selected component is displayed in the design area 202. If, on the other hand, the selected component is not a visual container component, then an ancestor of the selected component that is a visual container component is displayed in the design area 202 (with the selected component usually being visible within the boundaries of the displayed ancestor).

By “enlargement”, what is meant is that the displayed component is enlarged from a usual display size of the component in the layout editor 18. The enlargement may fill the design area 202. Enlargement of the displayed component is for the purpose of allowing component features to be more easily seen and to facilitate manipulation of any components contained by the displayed component.

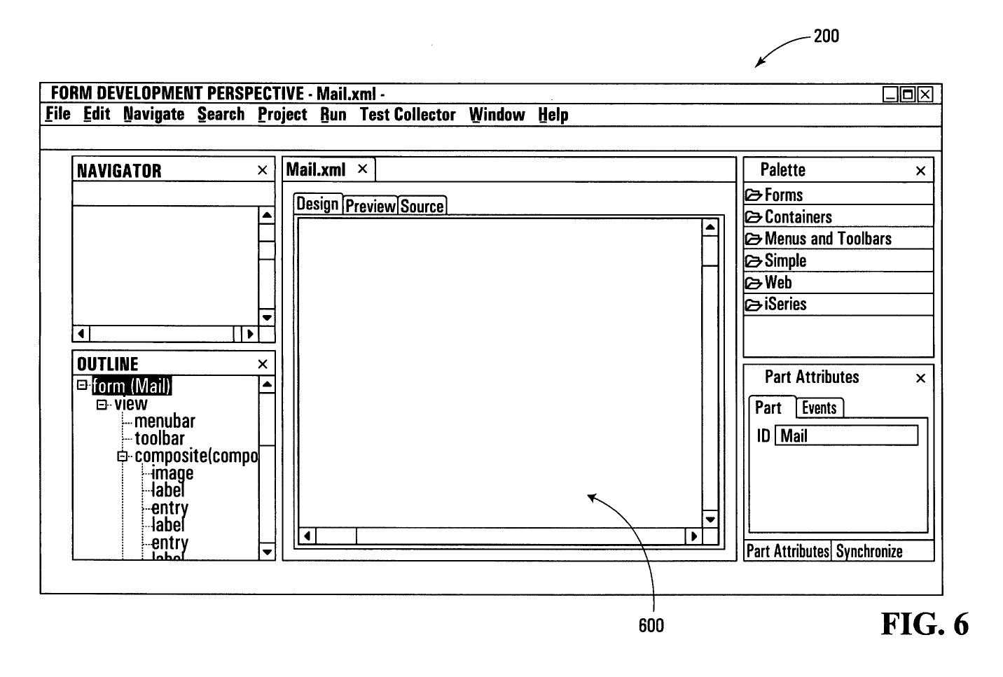

Operation of the layout editor 18 for displaying GUI components based on component selection is illustrated in FIG. 5 at 500. It will be appreciated that operation 500 is executed whenever a GUI component is selected (either by a designer or by the layout editor software 18).

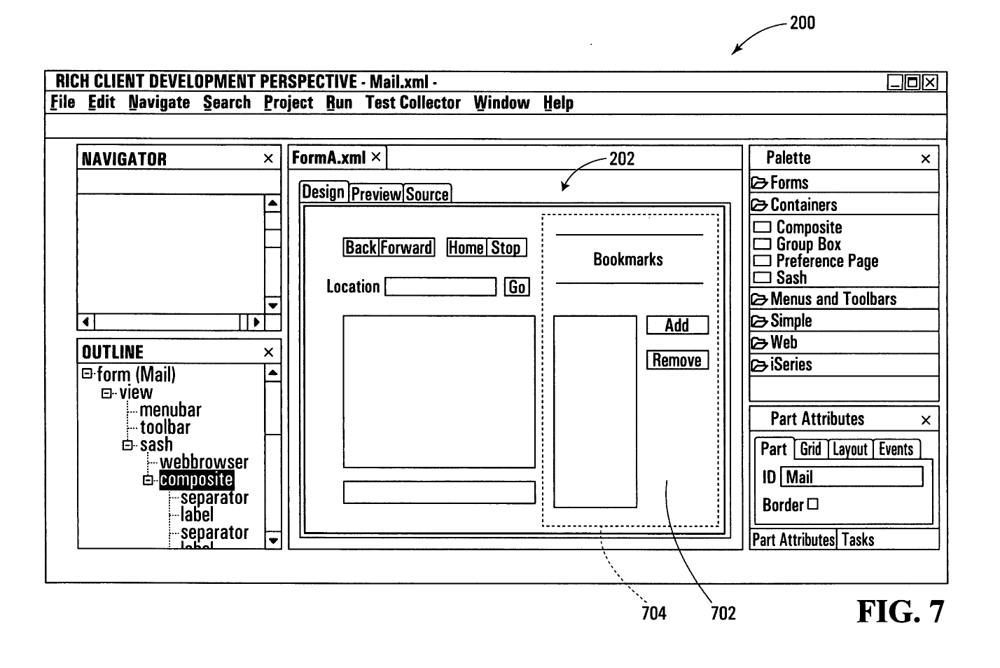

Operation 500 is described in conjunction with FIGS. 6 to 11, 12A and 12B, which illustrate the effect of selecting different types of GUI components.

Initially, a determination is made as to whether the selected GUI component is a visual GUI component (S502). If the selected GUI component is not a visual GUI component (e.g. it is a form), the design area 202 is cleared (S504). This is shown at 600 in GUI 200 of FIG. 6. Operation 500 terminates in this case.

Instead, if it is determined in S502 that the selected GUI component is in fact a visual GUI component, a further determination is then made as to whether the selected component is already highlighted (S506). A determination in the positive would indicate that the component is currently being reselected, i.e., is being selected for a second consecutive time, with the first selection having triggered a previous execution of operation 500.

Assuming that the selected component is not highlighted, i.e. that this is an initial selection rather than a reselection, a determination is then made as to whether another component is highlighted (S508). If another component is in fact highlighted, that component is unhighlighted (S510) to reflect the current selection.

Thereafter, operation depends upon whether the selected component is visible, i.e., was already displayed in the design area 202 of FIG. 2 prior to its selection.

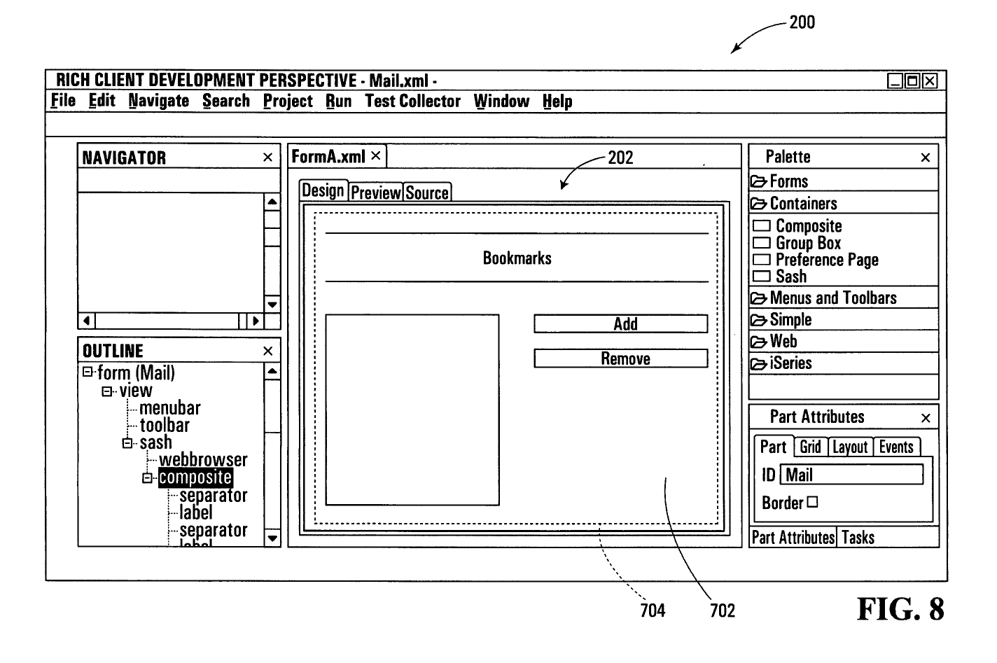

If the selected component is visible (S512), the component is highlighted (S514) and operation 500 terminates. This scenario is illustrated in FIG. 7. FIG. 7 illustrates the GUI 200 of the layout editor 18 after initial selection of composite 702, which was visible prior to selection. As can be seen, a highlight 704 consisting of a dashed outline has been applied to the composite 702 to reflect selection, yet no enlargement of composite 702 to fill design area 202 has been performed. The rationale for highlighting but not enlarging composite 702 in design area 202 upon initial selection is that initial selection of a visible component is often simply for purposes of displaying component properties rather than editing the component. Unnecessary display volatility is thus avoided.

Referring back to FIG. 5, if it is instead determined in S512 that the selected component is not visible, further operation depends upon whether the component is a visual container GUI component (S516).

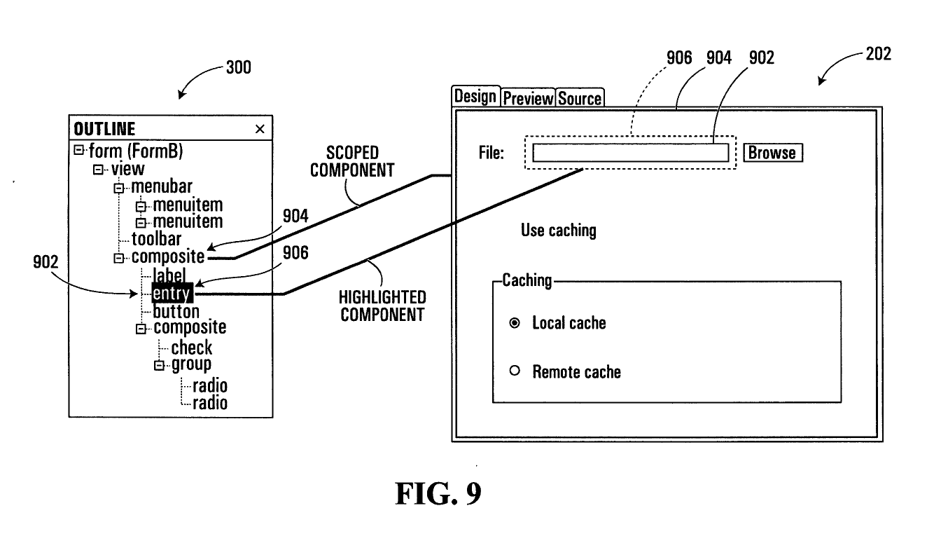

If the selected component is a visual container GUI component (S516), the component is automatically displayed so as to fill the design area (S518) and highlighted to reflect selection (S514). In the case of composite 702, this scenario is illustrated in FIG. 8. As illustrated, composite 702 is now enlarged to fill design area 202 and highlighted at 704 to reflect selection. In other words, composite 702 has become the “scoped component”. The rationale for enlarging composite 702 to fill design area 202 upon initial selection in this case is that, because composite 702 was not previously visible, it is assumed to be the only component of interest to the designer.

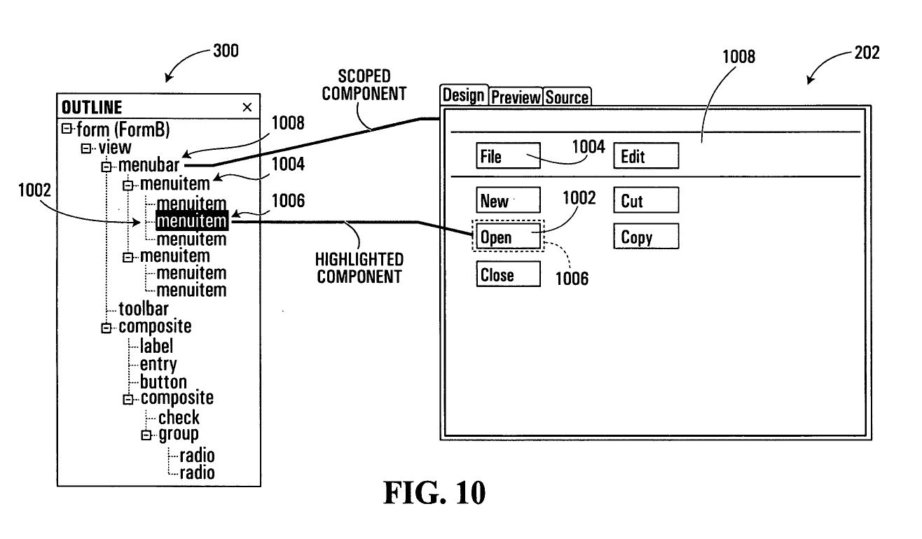

If, on the other hand, the selected component is not a visual container GUI component (S516—FIG. 5), the GUI component hierarchy is traversed upwardly until an ancestor container GUI component that is a (visual) container is identified (S520). The identified ancestor container GUI component, rather than the selected component, is automatically displayed so as to fill the design area (S524). The reason that visual components that are not visual container components are not enlarged upon selection is that enlargement of such components may not provide a benefit (for example, if the selected component is a push button, enlargement of the button to fill the design area may constitute an unnecessary level of magnification). The selected component is then highlighted (S514). This scenario is illustrated in FIGS. 9 to 11 for various types of non-container GUI components.

Referring to FIG. 9, outline view 300 and design area 202 of the layout editor GUI 200 are illustrated after selection (or reselection) of a non container component comprising a text entry box 902. The text entry box 902 is contained by a composite 904. Selection of the text entry box 902 is illustrated in both the outline view and the design area by highlighting 906 of the selected component, which highlighting is effected in those display areas by background shading and a dotted outline respectively. As can be seen in FIG. 9, the composite 904 is the scoped component.

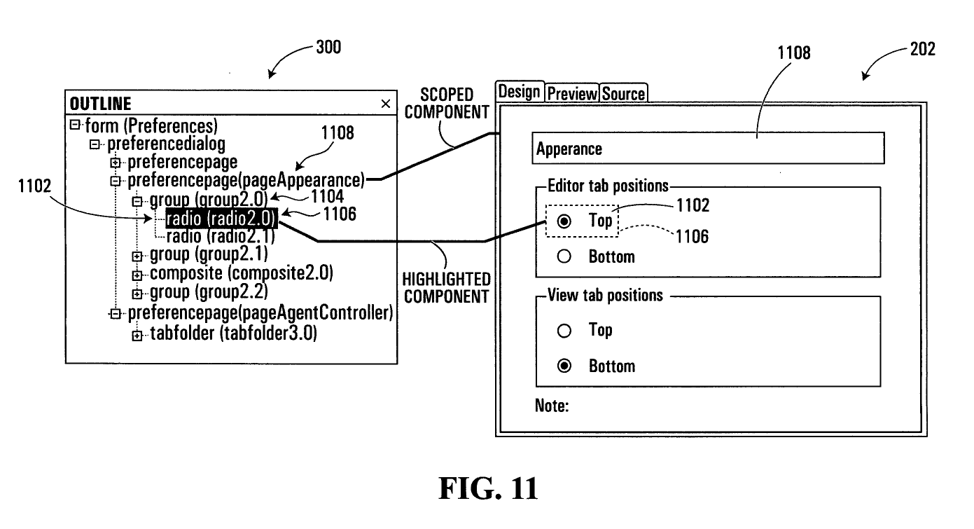

FIG. 10 illustrates outline view 300 and design area 202 of the layout editor software GUI 200 after selection (or reselection) of a non-container GUI component consisting of a menu item 1002. The menu item 1002 is nested within another menu item 1004 in a menu bar 1008. Highlighting 1006 reflects the status of menu item 1002 as the selected component, while enlargement of menu bar 1008 in the design area 202 illustrates that menu bar 1008 has become the scoped component. This example illustrates a case in which the scoped component is not the direct parent of the selected component, but rather is a more remote ancestor (grandparent).

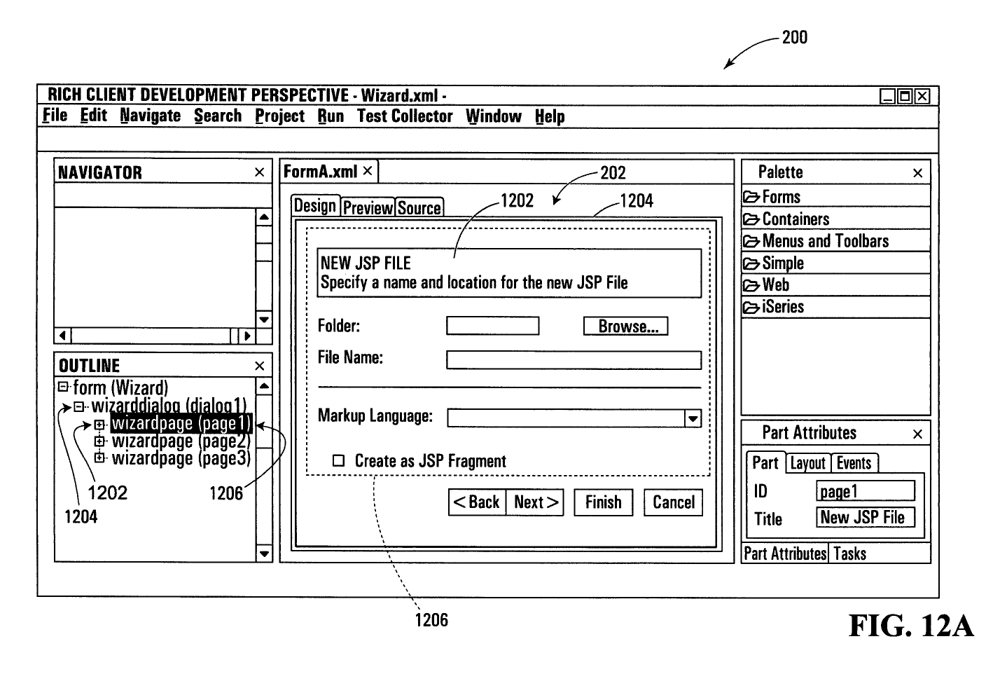

FIG. 11 illustrates outline view 300 and design area 202 after selection (or reselection) of a radio button 1102 of a group 1104 of a preference page 1108. Preference pages are analogous to wizard pages. Highlighting 1106 reflects the status of radio button 1102 as the selected component, while enlargement of preference page 1108 in the design area 202 illustrates that it has become the scoped component. Like FIG. 10, this is another example of a scoped component being the grandparent of a selected component.

Referring back to FIG. 5, if it is determined in S506 that the selected component is already highlighted, this indicates that selection of the component in fact constitutes reselection of the component. In this case some of the above described operation (e.g. unhighlighting, highlighting) is unnecessary. If the selected component is a visual container GUI component (S526), operation per S518 and S514, as described above, is performed. This causes the selected component to become the scoped component in the event that initial selection had not resulted in the selected component becoming the scoped component. Otherwise, operation 500 terminates, with no enlargement of non-container GUI components being performed.

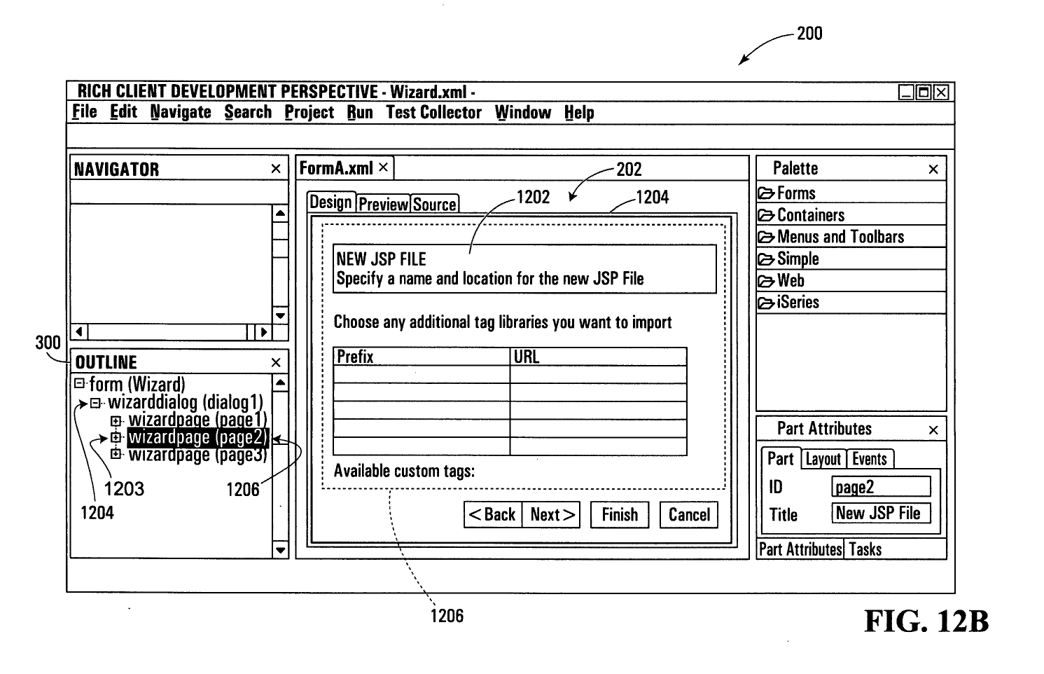

FIGS. 12A and 12B respectively illustrate the GUI 200 of layout editor software 18 after selection of the first and second page of a wizard respectively. As shown in FIG. 12A, selection of the first wizard page 1202 of a wizard 1204 results in highlighting 1206 of the wizard page 1202 (in outline view 300 and design area 202) and also results in the wizard 1204 becoming the scoped component in design area 202. When the second wizard page 1203 is selected (FIG. 12B), the GUI is the same as in FIG. 12A with the exception that second wizard page 1203 has become the highlighted component rather than first wizard page 1202, which is no longer displayed in the design area 202.

As should now be appreciated, selection of a visual container GUI component will cause that component to become the scoped component if the component was not already visible in the design area 202. Reselection of a visual container GUI component will invariably cause that component to become the scoped component in the present embodiment. On the other hand, selection of a GUI component that is not a visual container will not cause that component to become the scoped component, but instead will cause the closest ancestor visual container to become the scoped component (unless the selected component is not visual, in which the design area 202 is cleared).

As will be appreciated by those skilled in the art, modifications to the above-described embodiment can be made without departing from the essence of the invention. For example, alternative embodiments may invariably cause a visual container GUI component to become scoped upon its initial selection, even when it was already visible. That is, in such alternative embodiments, scoping of components is always performed on the basis of an initial selection (i.e. a designer needn't ever make a reselection in order for any component to become scoped). Of course, the display volatility of such embodiments may be somewhat higher than the embodiment described above.

It should also be appreciated that it is not necessary for a scoped component to fill the design area 202. For example, a scoped component may be enlarged from its usual display size, but not be made so large as to fill the design area 202.

It should further be understood that, while the design area 202 is described as a “screen area”, if the display 12 does not have a screen, the design area 202 may not in fact be a screen area. For example, if display 12 is a projector, design area 202 may be a projection area.

In another possible variation, when a component that is not a visual container is selected so as to result in the display of an ancestor visual container in the design area 202, the ancestor that is displayed need not necessarily be the closest visual container ancestor to the selected component. For example, a “second-closest” visual container ancestor may instead be displayed. This may be elected because enlargement of the closest ancestor visual container from its usual display size to fill the design area 202 would constitute an unnecessary degree of magnification.

Other modifications will be apparent to those skilled in the art and, therefore, the invention is defined in the claims.

1. A method for graphical layout, comprising the steps of:
providing a design area for displaying a graphical layout;
providing a list of visual components capable of being displayed in the design area, the list including a container component capable of being displayed in a first size in the design area, the list further including an element component displayable within the boundaries of the container component;
selecting the container component;
enlarging the container component to a second size greater than the first size, and displaying the enlarged container component in the display area.

2. The method of claim 1, further comprising the steps of:
highlighting the first size of the container component in the display area in response to the step of selecting the container component;
reselecting the container component, such that the step of enlarging the container component is in response to this step of reselecting the container component.

3. A method for graphical layout, comprising the steps of:
providing a design area for displaying a graphical layout;
providing a hierarchal list of visual components capable of being displayed in the design area, the hierarchal list including a container component capable of being displayed in a first size in the design area, the list further including a child component displayable within the boundaries of the container component, the child component being a descendant of the container component in the hierarchal list;
selecting the child component;
enlarging the container component to a second size greater than the first size, and displaying the enlarged container component in the display area such that the child component is displayed within the boundaries of the container component.

5. A computer readable medium having computer program code for use in graphical layout and, when executed by a computer, the computer program code causes the computer to:
display a design area for displaying a graphical layout;
display a list of visual components capable of being displayed in the design area, the list including a container component capable of being displayed in a first size in the design area, the list further including an element component displayable within the boundaries of the container component;
provide for the selection of the container component;
enlarge the container component to a second size greater than the first size, and display the enlarged container component in the display area.

6. The computer readable medium of claim 5, wherein the computer program code further causing the computer to:
highlight the container component in the display area in response to a selection of the container component;
provide for the reselection of the container component, such that the enlargement of the container component is in response to a reselection of the container component.

7. A computer readable medium having computer program code for use in graphical layout and, when executed by a computer, the computer program code causes the computer to:
display a design area for displaying a graphical layout;
display a hierarchal list of visual components capable of being displayed in the design area, the hierarchal list including a container component capable of being displayed in a first size in the design area, the list further including a child component displayable within the boundaries of the container component, the child component being a descendant of the container component in the hierarchal list;
provide for the selection of the child component;
enlarge the container component to a second size greater than the first size, and display the enlarged container component in the display area such that the child component is displayed within the boundaries of the container component.
